(19) United States
(12) Patent Application Publication
(10) Pub. No.: US 2013/0076693 A1
(43) Pub. Date: Mar. 28, 2013

(54) TAPPING DETECTION METHOD OF OPTICAL NAVIGATION MODULE

(71) Applicants: TONG-TEE TAN, SINGAPORE (SG); SRINIVASAN LAKSHMANAN CHETTIAR, SINGAPORE (SG)

(72) Inventors: TONG-TEE TAN, SINGAPORE (SG); SRINIVASAN LAKSHMANAN CHETTIAR, SINGAPORE (SG)

(73) Assignee: LITE-ON SINGAPORE PTE. LTD., MIDVIEW CITY (SG)

(21) Appl. No.: 13/241,204

(22) Filed: Sep. 23, 2011

(51) Int. Cl. G06F 3/042

(52) U.S. Cl. 345/175

(57) ABSTRACT

A tapping detection method of an optical navigation module is disclosed. The module includes an optical sensor and a processor. The method includes steps of calculating a displacement quantity of an object contacting with the optical navigation module according to a sense image sensed by the optical sensor, and comparing the displacement quantity with a displacement threshold value. When the displacement quantity is smaller than the displacement threshold value, the method further includes steps of calculating a brightness difference value of the sense image, and comparing the brightness difference value with a brightness threshold value. When the brightness difference value is smaller than the brightness threshold value, the optical navigation module may be determined to be tapped by the object.

### BACKGROUND OF THE INVENTION

1. Field of the Invention

The present invention relates to a detection method; in particular, to a tapping detection method of an optical navigation module.

2. Description of Related Art

The conventional navigation module uses a mechanical switch for determining whether an electronic device receives a tapping or scrolling command. According to the switching operation of users for closing or opening the electrical circuits, the processor of the electrical device may determine the operation thereof. However, the manner described above may need to dispose a switch at the electronic device, and may provide a space at the navigation device for disposing the hardware component.

Additionally, the determination commands of the navigation device may generate misjudgment because of the operations of users, and the navigation device may generate wrong responses.

### SUMMARY OF THE INVENTION

According to an embodiment of the present invention, a tapping detection method of an optical navigation module having an optical sensor and a processor are disclosed. The method includes steps of calculating a displacement quantity of an object contacting with the optical navigation module according to the sense image sensed by the optical sensor, and comparing the displacement quantity with a displacement threshold value. When the displacement quantity is smaller than the displacement threshold value, the method may include steps of calculating a brightness difference value of the sense image, and comparing the brightness difference value with a brightness threshold value. When the brightness difference value is smaller than the brightness threshold value, the optical navigation module may be determined to be tapped by the object.

A tapping detection of an optical navigation module may also be disclosed according to another embodiment of the present invention. The method includes steps of calculating a displacement quantity of an object contacting with the optical navigation module according to a sense image sensed by the optical sensor, and comparing the displacement quantity with the displacement threshold value. When the displacement quantity is smaller than the displacement threshold value, the method may further include steps of calculating a brightness difference value of the sense image, and comparing the brightness difference value with a brightness threshold value. When the brightness difference value is smaller than the brightness threshold value, the optical navigation module may be determined to be tapped by the object, and a time counting of a tapping time may be executed. When the tapping time is not expired to end, the image characteristic value of a next sense image may be calculated, and may be compared with the navigation threshold value. When the image characteristic value is smaller than the navigation threshold value, the time counting of the tapping time may be stopped, and the optical navigation module may be determined to be tapped.

A computer readable recording medium may be provided according to an embodiment of the present invention. The medium is used for recording a set of program code which may execute the aforementioned tapping detection method.

For further understanding of the present disclosure, reference is made to the following detailed description illustrating the embodiments and examples of the present disclosure. The description is only for illustrating the present disclosure, not for limiting the scope of the claim.

### BRIEF DESCRIPTION OF THE DRAWINGS

The drawings included herein provide further understanding of the present disclosure. A brief introduction of the drawings is as follows:

FIG. 1 shows a schematic diagram of an electronic device according to an embodiment of the present invention;

FIG. 2 shows a block diagram of an optical navigation module according to an embodiment of the present invention;

FIGS. 3A to 3C show schematic diagrams of sense images according to an embodiment of the present invention;

FIG. 4 shows a flow chart of a tapping detection method of an optical navigation module according to an embodiment of the present invention; and

FIGS. 5A and 5B show a flow chart of another tapping detection method of an optical navigation module according to an embodiment of the present invention.

### DETAILED DESCRIPTION OF THE PREFERRED EMBODIMENTS

The aforementioned illustrations and following detailed descriptions are exemplary for the purpose of further explaining the scope of the present invention. Other objectives and advantages related to the present invention will be illustrated in the subsequent descriptions and appended drawings.

[Embodiments of an Optical Navigation Module and a Tapping Detection Method Thereof]

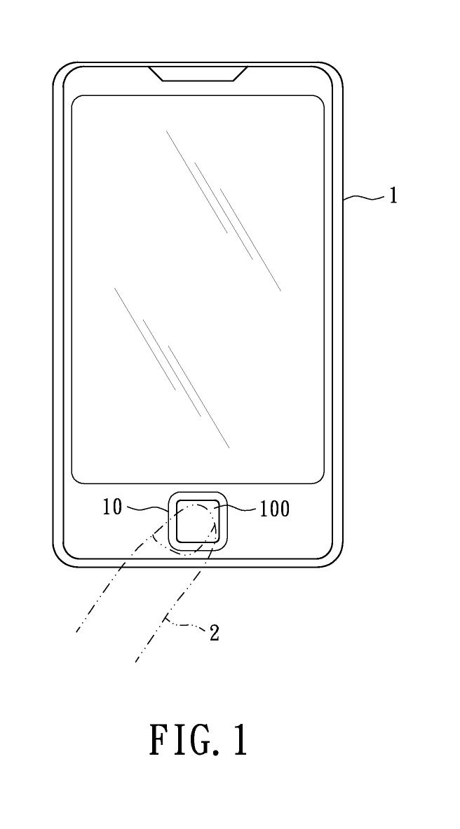

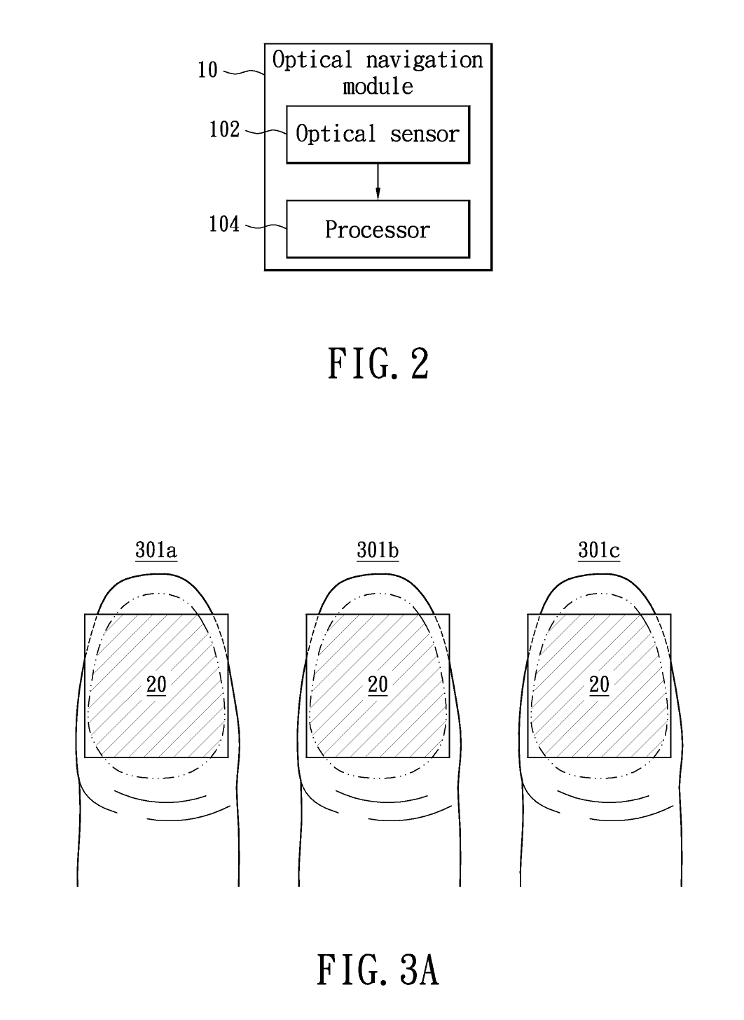

Please refer to FIG. 1 which is a schematic diagram of an electronic device according to an exemplary embodiment. The electronic device 1 includes an optical navigation module 10. The electronic device 1 may be a smart phone, a personal digital assistant, or a notebook computer. FIG. 1 takes the smart phone as an example. Please refer to FIG. 2 which shows a block diagram of the optical navigation module 10 according to an exemplary embodiment. The optical navigation module 10 includes at least a sense plane 100 (see FIG. 1) which is disposed at the surface of the electronic device 1, and an optical sensor 102 and a processor 104 which are disposed inside the electronic device 1. The optical sensor 102 may continuously sense and generate a plurality of sense images. The processor 104 may analyze and process the sense images, for determining operation modes of an object 2 on the sense plane 100, and for further controlling the electronic device 1 to perform corresponding works.

The optical navigation module 10 may be an optical finger navigation module. The optical sensor 102 may be a complementary metal oxide semiconductor (CMOS) sensor or a charge coupled device (CCD) sensor, and the processor 104 may be a digital signal processor, a microcontroller, an application specific integrated circuits (ASIC), or other kinds of control component. The object 2 which is operating on the sense plane 100 may be a finger of a user or a touch pen, or the like.

The processor 104 may calculate every sense image for determining the operations of the object 2 relative to the optical navigation module 10, such as tapping on the sense plane 100, or lifting from the sense plane 100 and being away from the module 10.

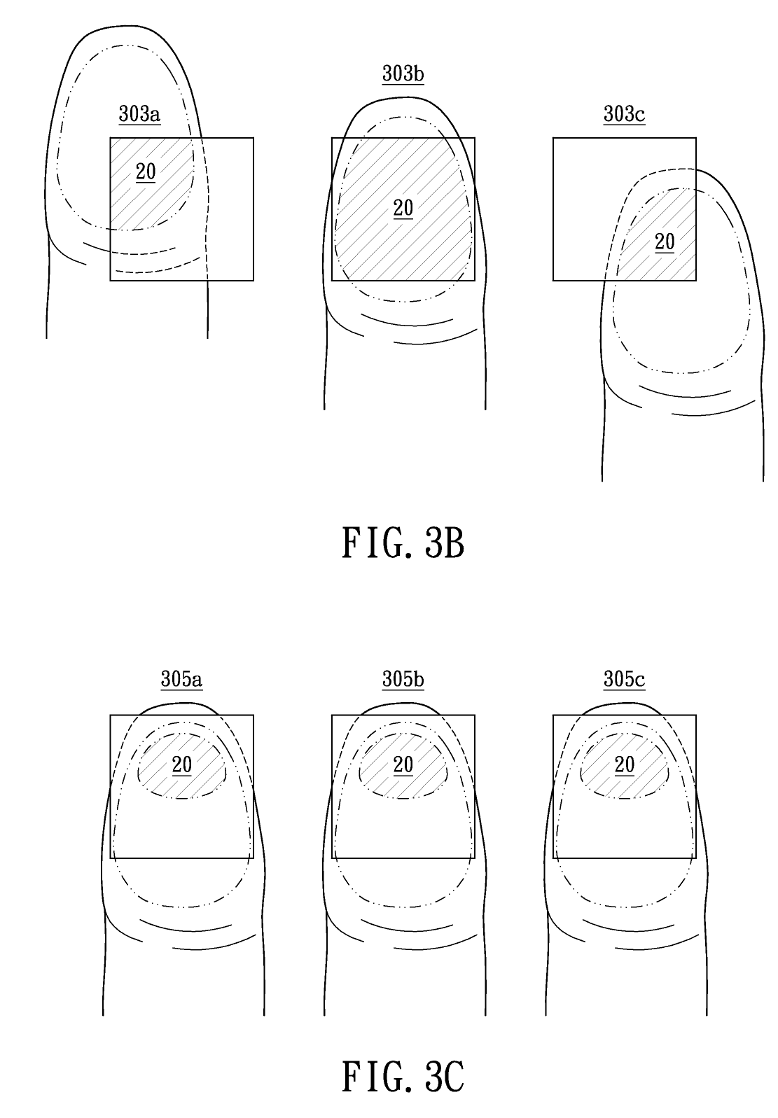

Please refer to FIGS. 3A and 3B which are schematic diagrams of the sense images. When the object 2 touches with the sense plane 100 on approximately the same location, several sense images continuously sensed by the optical sensor 102 may show similar screen contents, such as the sense images 301a, 301b, and 301c shown in FIG. 3A. The processor 104 may thus determine that the object 2 taps on the optical navigation module 10 at a fixed point. When the object 2 slides on the sense plane 100, the successive sense images generated by the optical sensor 102 may capture different screens of the object images 20 which are at different locations. As the sense images 303a, 303b, and 303c shown in FIG. 3B, the processor 104 may determine that the object 2 moves from the upper left side to the lower right side of the sense plane 100 by calculating and comparing the differences between the pixel value of each image.

However, when the object 2 moves fast on the sense plane 100, the processor 104 may mistakenly determine that the object 2 is tapping instead of sliding on the module 10. As shown in FIG. 3C, the object 2 has slid rapidly from up to down several times during the time sense images 305a to 305c are captured, however the optical sensor 102 does not capture images when the object 2 is moved to the bottom, thus the object images 20 in the sense images 305a to 305c may be similar to those in sense images 301a to 301c. Therefore, the processor 104 may misjudge the operation mode of the object 2 operating on the optical navigation module 10.

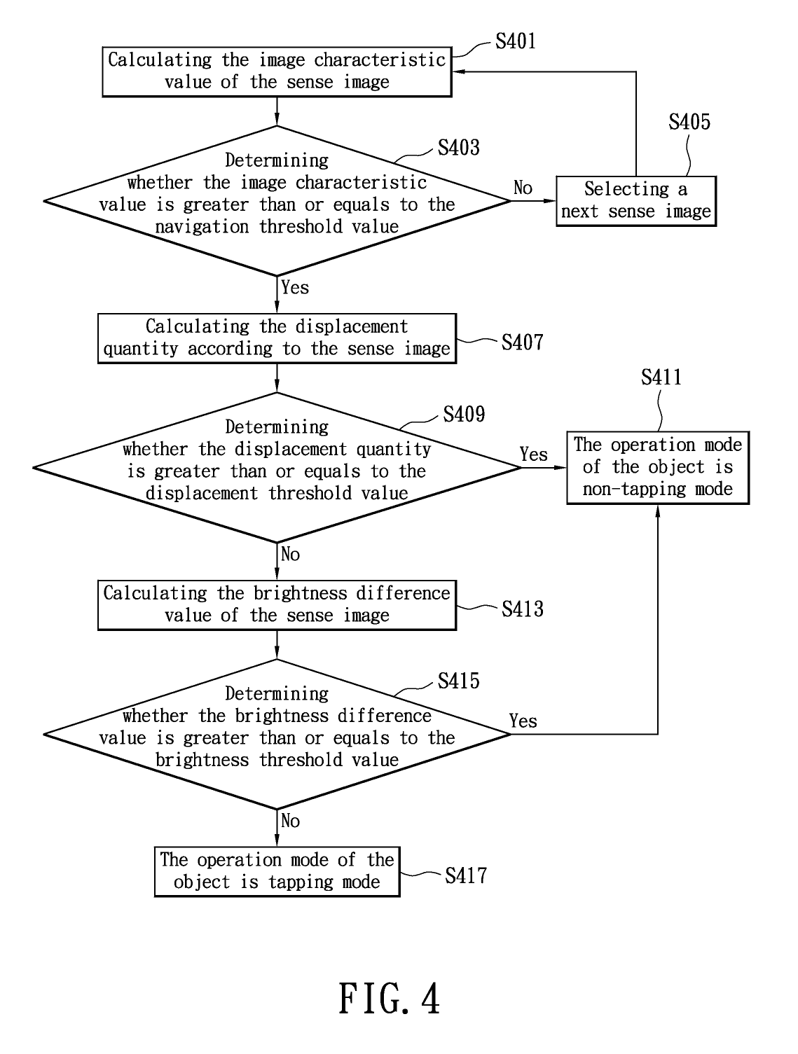

Please refer to FIG. 4 which shows a flow chart of a method executed by the processor 104, and the method is for executing a program code in order to detect whether the optical navigation module 10 is tapped or not.

When the processor 104 receives a sense image sensed by the optical sensor 102, an image characteristic value of the sense image may be calculated (S401). For example, the image characteristic value may be a pixel average value or an image contrast of the detected sense image. The processor 104 may also compare the image characteristic value with a predetermined or dynamically determined navigation threshold value, for determining whether the image characteristic value is greater than or equals to the navigation threshold value (S403). If the result of comparison indicates that the image characteristic value is smaller than the navigation threshold value, a sense image next to the calculated sense image may be selected (S405), and the method may go back to step S401 for calculating and comparing the newly selected sense image.

The optical sensor 102 may continuously sense and generate sense images, when the object 2 leaves the sense plane 100, the pixel average value of the sense image detected by the optical sensor 102 may become relatively small, and the image contrast may become unobvious in the meantime. On the other hand, when the object 2 contacts with the sense plane 100, the pixel average value may be relatively great and the image contrast may be relatively high. Therefore, the comparison in step S403 may be used to determine whether the object image 20 of the object 2 is presented in the sense image (see FIG. 3A). When the image characteristic value of the sense image passes the sieving of the navigation threshold value, the processor 104 may continue the successive calculation and determination according to the data of the sense images which includes the object images 20.

When the comparison result of the step S403 is yes, the processor 104 may further compare out vertical and horizontal displacement of the object image, and calculate a displacement quantity among the sense image in correspondence to the object 2 (S407).

The processor 104 may then compare the displacement quantity corresponding to the sense image with a displacement threshold value (S409), for determining whether the object 2 continuously contacts substantially the same location of the sense plane 100 or moves around the sense plane 100 and thus generate obvious displacement.

Please compare FIG. 3A with FIG. 3B. Comparing to the sense images in FIG. 3B, the displacement quantities of the object images 20 in the sense images 301a to 301c of FIG. 3A are very small. The respective object images captured by the sense images 303a to 303c in FIG. 3B show obvious changes of the displacement quantities. When the displacement quantity of the sense image is greater than or equals to the displacement threshold value, the processor 104 may determine the object 2 does not tap on the sense plane 100 at the same location, thus the operation mode of the object 2 may be determined to be non-tapping mode (S411). The operation of the object 2 may be sliding or dragging on the sense plane 100.

When the determination result shows that the displacement quantities corresponding to the sense images are smaller than the displacement threshold value, the processor 104 may further calculate a brightness difference value of the sense image (S413), and may compare the brightness difference value with a brightness threshold value for determining whether the brightness difference value is greater than or equals to the brightness threshold value or not (S415).

In this embodiment, the brightness difference value may be a difference value between a maximum pixel value and a minimum pixel value among the pixels of the sense image. When the object images 20 corresponding to the object 2 is included in the sense image, the pixel values corresponding to the object images 20 in the sense image are relatively great. And the other part of the sense image may have relatively small pixel values.

Please refer to the following descriptions along with FIGS. 3A and 3C. As shown in FIG. 3A, when the object 2 contacts with the sense plane 100 of the optical navigation module 10 by a tapping manner, because the object 2 may contact with the sense plane 100 at approximately the same location, the pixel values of the pixels of each sense image 301a, 301b, or 301c may be relatively close to one another, and the differences between the maximum pixel values and the minimum pixel values thereof may also be relatively small. In other words, when the object 2 is in tapping mode, the corresponding brightness difference values may be relatively small.

On the other hand, when the object 2 touches the sense plane 100 of the optical navigation module 10 by a manner of fast sliding, even the displacement quantities of the object images 20 are smaller than the displacement threshold value, but because the object 2 actually lifts after short distance movement, the sense images sensed by the optical sensor 102 may easily generate part of the screen has the object images 20 while other part does not, as shown in FIG. 3C. Thus the difference between the maximum pixel value and the minimum pixel value of the sense image (such as 305a) may greater than the pixel value difference of the sense image under the tapping mode. In other words, when the operation mode of the object 2 is non-tapping mode, the brightness difference values of the sense image may have relatively larger differences among one another.

Therefore, when the determination result shows that the brightness difference value is larger than or equals to the brightness threshold value, the processor 104 may determine that the object 2 is at non-tapping mode when the sense image is captured (S411), and the operation mode of the object 2 may be dragging data or scrolling a moving bar. On the other hand, after the double filtering via displacement threshold value and the brightness threshold value, and the processor 104 determine that the displacement quantity is smaller than the displacement threshold value and the brightness difference value is also smaller than the brightness threshold value, the operation mode of the object 2 may be identified as tapping mode (S417).

[Another Embodiment of Tapping Detection Method of an Electronic Device]

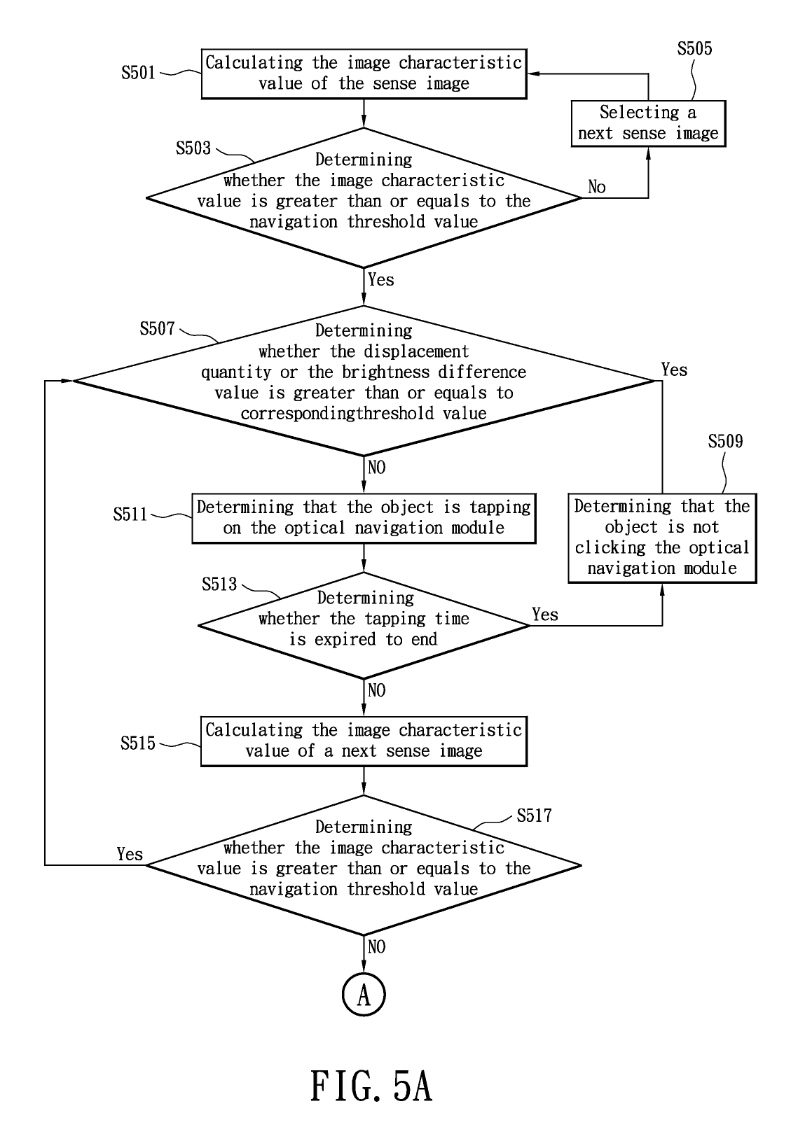

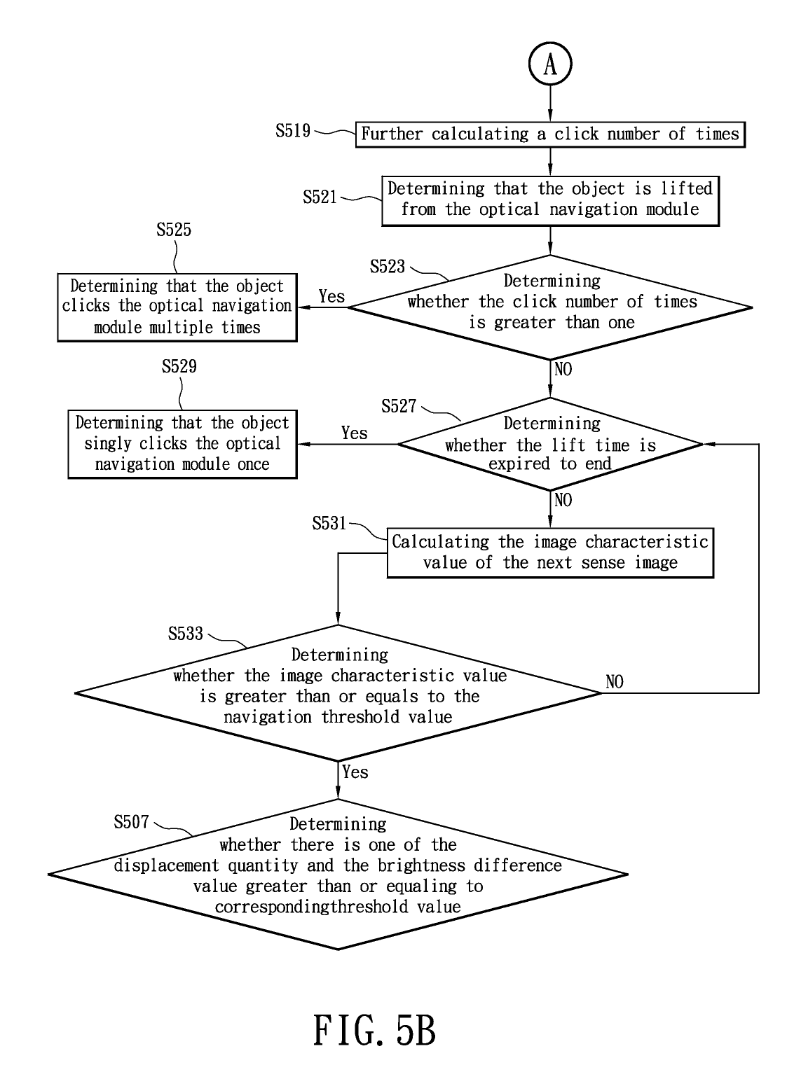

FIGS. 5A and 5B show a flow chart of another tapping detection method according to an exemplary embodiment. Please refer to FIGS. 5A and 5B along with FIGS. 1 and 2 which shows a schematic diagram and a block diagram respectively.

The tapping detection method of this embodiment may not only distinguish whether the object 2 contacts with the optical navigation module 10 by tapping instead of sliding or scrolling on it, but also determine whether the object 2 presses or clicks the optical navigation module 10.

Please refer to FIG. 5A. When the optical sensor 102 successively senses and generates several sense images, the processor 104 may receive and analyze every sense image in sequence. Every time after the processor 104 receives a sense image, an image characteristic value of the sense image may be calculated (S501). Then the image characteristic value may be compared with a predetermined or dynamically determined navigation threshold value, for determining whether the image characteristic value is greater than or equals to the navigation threshold value (S503). If the image characteristic value is smaller than the navigation threshold value, the processor 104 may determine that the object 2 is not operating on the optical navigation module 10. After that, the optical navigation module 10 may stay at a standby mode waiting for the operation of a user. The processor 104 may select a next sense image (S505) and go back to step S501 for calculating the image characteristic value of the newly selected sense image.

If the determination result indicates that the image characteristic value is greater than or equals to the navigation threshold value, the processor 104 may further perform double determinations on the sense image. The double determinations may include determining whether the displacement quantity of the sense image is greater than or equals to the displacement threshold value or not, and determining whether the brightness difference value is greater than or equals to the brightness threshold value (S507).

When one of or both of the results of the aforementioned double determinations is positive, the processor 104 may determine that the operation of the object 2 does not match the characteristics of tapping operation which include small displacement quantity and touching the sense plane 100 with a pattern of fixed-point contacting. Thus, the operation mode of the object 2 is determined to be non-tapping mode (S509). At the moment, the action executed by the object 2 may be scrolling. On the other hand, when the results of the double determinations indicate that both the displacement quantity and the brightness difference value are smaller than the corresponding threshold values, the operation mode of the object 2 may be determined to be tapping mode (S511).

When the processor 104 determines that the object 2 taps on the optical navigation module 10, it may start a time counting according to the time length of a tapping time, and may determine whether the tapping time is expired (S513). If the object 2 is tapping on the optical navigation module 10 and the tapping time is expired to end, that means the object 2 contacts with the sense plane 100 for a period of time, thus the processor 104 may determine that the action executed by the object 2 is not clicking on the sense plane 100 (S509). More specifically, the object 2 may be pressing on the sense plane 100.

If the tapping time is not expired to end, the processor 104 may continuously select the next sense image, and may calculate the image characteristic value of the selected sense image (S515), as the operations shown in S501 and S503. After that, the processor 104 may determine whether the image characteristic value of the sense image passes the sieving of the navigation threshold value or not (S517). If the image characteristic passes the sieving of the navigation threshold value, the processor 104 may go back to step S507, for determining that the sense image passes the double determinations including the displacement threshold value and the brightness threshold value. If the displacement quantity or the brightness difference value of the sense image is greater than or equals to the determination of corresponding threshold values, the processor 104 may determine that during the time the successive sense images are calculated, the object 2 has touched and moved from one location to another on the sense plane 100. Thus the object 2 may be determined not clicking on the optical navigation module 10 (S509).

Reference is made to FIG. 5B. If the processor 104 determines that the image characteristic value of one of the successively detected sense images is smaller than the navigation threshold value when the tapping time is not expired (that is, the determination result of the step S517 shown in FIG. 5A is negative), a click number of times may be accumulated (S519) and the time counting of the tapping time may be stopped. The processor 104 may determine that the object 2 is lifted from the sense plane 100 (S521). Each click number of times indicates that the object 2 taps and then lifts from the optical navigation module 10 once, that is, one “clicking” is performed. When the object 2 is determined lifted from the sense plane 100, the processor 104 may execute a time counting according to a lift time.

After that, the processor 104 may determine whether the click number of times is more than one (S523). If the determination result is positive, that means the object 2 clicks successively on the sense plane 100 for multiple times. Then the processor 104 may further control the electronic device 1 for executing a multi-click operation corresponding to the multiple clicking by the object 2 (S525).

On the other hand, if the click number of times does not exceed one time, the processor 104 may further determine whether the lift time is expired to end or not (S527). The lift time may be used for determining whether the object 2 taps on the sense plane 100 again in a short period of time after lifting from the sense plane 100.

Therefore, when the click number of time does not exceed one (the determination result of step S523 is negative) and the lift time is expired to end (the determination result of step S527 is negative), the processor 104 may determine that the object 2 clicks the optical navigation module 10 for one single time and may further control the electronic device 1 for executing an operation corresponding to the single click (S529).

After determining that the object 2 is continuously or singly clicking on the optical navigation module 10, the processor 104 may reset the click number of times to zero for recording the click number of times again according to the operations of the object 2.

If the lift time is not expired to end (the determination of step S527 is negative), the processor 104 may continuously select another successive sense image, and may calculate the image characteristic values of the latest selected sense image (S531) and determine whether the image characteristic values of the sense image is greater than or equals to the navigation threshold value (S533). If the determination result of step S533 is negative, that means the object 2 is still lifting, thus the processor 104 may go back to step S527 for determining whether the lift time is expired to end or not. On the other hand, if the determination result of step S533 is positive, that means after the object 2 corresponding to the former sense image is determined to lift from the sense plane 100, the object 2 corresponding to the next sense image is determined to contact the sense plane 100 again. Thus, the processor 104 may stop the time counting of the lift time, and may go back to step S507 (shown in both FIGS. 5A and 5B) again for determining whether the operation mode of the object 2 is tapping mode or not.

[Possible Efficiencies of the Embodiments]

According to the embodiments of the present invention, the displacement quantities and the brightness differences of the sense image are both used as sieving conditions for double determining whether the object taps on the optical navigation module or not, which decreases the possibility of misjudging sliding to tapping.

In addition, the tapping detection method of the optical navigation module disclosed in the aforementioned embodiments may precisely determine that the operation mode of the object is tapping mode or non-tapping mode. Moreover, the method may also determine whether the object clicks on the sense plane of the optical navigation module or not. Thus, the electronic device may be able to execute corresponding operations correctly.

Moreover, the tapping detection method of the optical navigation module disclosed in the aforementioned embodiments may further accurately distinguish whether the object is single-clicking or multi-clicking on the module, and thus control the electronic device to perform corresponding work correctly.

According to the tapping detection method of the embodiments of the present invention, a processor may be used to execute program codes for increasing detection mechanics, thus the electronic device does not need any extra hardware for determining the operation statuses of the object. Therefore, the requisite materials of the electronic device may be reduced, which further decreases the cost for manufacturing the electronic device.

Some modifications of these examples, as well as other possibilities will, on reading or having read this description, or having comprehended these examples, will occur to those skilled in the art. Such modifications and variations are comprehended within this disclosure as described here and claimed below. The description above illustrates only a relative few specific embodiments and examples of the present disclosure. The present disclosure, indeed, does include various modifications and variations made to the structures and operations described herein, which still fall within the scope of the present disclosure as defined in the following claims.

What is claimed is:

1. A tapping detection method of an optical navigation module which includes an optical sensor and a processor, the method comprising:
calculating a displacement quantity of an object contacting with the optical navigation module according to a sense image sensed by the optical sensor;
comparing the displacement quantity with a displacement threshold value;
calculating a brightness difference value of the sense image when the displacement quantity is smaller than the displacement threshold value;
comparing the brightness difference value with a brightness threshold value; and
determining that the optical navigation module is tapped by the object when the brightness difference value is smaller than the brightness threshold value.

2. The tapping detection method according to claim 1, wherein after comparing the displacement quantity with the displacement threshold value, further comprises:
determining that the optical navigation module is not tapped when the displacement quantity is greater than or equals to the displacement threshold value.

3. The tapping detection method according to claim 1, wherein after comparing the brightness difference value with the brightness threshold value, further comprises:
determining that the optical navigation module is not tapped when the brightness difference value is greater than or equals to the brightness threshold value.

4. The tapping detection method according to claim 1, wherein before calculating the displacement quantity, further comprises:
calculating an image characteristic value of the sense image; and
comparing the image characteristic value with a navigation threshold value, for calculating the displacement quantity when the image characteristic value is greater than or equals to the navigation threshold value.

5. The tapping detection method according to claim 4, wherein the image characteristic value is an average value or an image contrast of a plurality of pixels of the sense image.

6. The tapping detection method according to claim 1, wherein the brightness difference value is a difference value between a maximum pixel value and a minimum pixel value of a plurality of pixels of the sense image.

7. A tapping detection method of an optical navigation module including an optical sensor and a processor, the method comprising:
calculating a displacement quantity of an object contacting with the optical navigation module according to a sense image which is sensed by the optical sensor;
comparing the displacement quantity with a displacement threshold value;
calculating a brightness difference value of the sense image when the displacement quantity is smaller than the displacement threshold value;
comparing the brightness difference value with a brightness threshold value;
when the brightness difference value is smaller than the brightness threshold value, determining that the optical navigation module is tapped by the object, and starting time counting of a tapping time;
when the tapping time is not expired, calculating an image characteristic value of a next sense image of the sense image, and comparing the image characteristic with a navigation threshold value; and
when the image characteristic value is smaller than the navigation threshold value, stopping counting the tapping time, and determining that the optical navigation module is clicked.

8. The tapping detection method according to claim 7, wherein after calculating the image characteristic value and comparing the image characteristic value with the navigation threshold value, further comprises:
when the image characteristic value is greater than or equals to the navigation threshold value, returning to the step of calculating the displacement quantity according to the sense image, until the image characteristic value of the sense image been calculated is smaller than the navigation threshold or the tapping time is expired.

9. The tapping detection method according to claim 8, wherein when the image characteristic value is smaller than the navigation threshold value, further comprises:
determining that the object is lifted from the optical navigation module;
accumulating a click number of times;
determining whether the click number of times is greater than one or not; and
when the click number of times is greater than one, determining that the optical navigation module is successively clicked, and executing a continuous click operation corresponding to the successive clicking.

10. The tapping detection method according to claim 9, wherein after determining whether the click number of times is greater than one or not, further comprises:
when the click number of times is not greater than one, determining whether a lift time is expired; and
when the lift time is expired, determining that the optical navigation module has been clicked by a single clicking, and executing a single click operation corresponding to the single clicking.

11. The tapping detection method according to claim 10, wherein after determining whether the lift time is expired, further comprises:
when the lift time is not expired, calculating the image characteristic value of a next sense image, and comparing the image characteristic value of the next sense image with the navigation threshold value;
when the calculated image characteristic value is determined greater than or equals to the navigation threshold value before the lift time is expired, returning to the step of calculating the displacement quantity according to the sense image, until the image characteristic value is smaller than the navigation threshold or the tapping time is expired; and
when the image characteristic value is smaller than the navigation threshold value before the lift time is expired, returning to the step of calculating the image characteristic of the next sense image and comparing the image characteristic value with the navigation threshold value, until the image characteristic value been calculated is greater than or equals to the navigation threshold value or the lift time is expired.

12. The tapping detection method according to claim 7, wherein after comparing the displacement quantity with the displacement threshold value, further comprises:
when the displacement quantity is greater than or equals to the displacement threshold value, determining that the optical navigation module is not tapped.

13. The tapping detection method according to claim 7, wherein after comparing the brightness difference value with the brightness threshold value, further comprises:
when the brightness difference value is greater than or equals to the brightness threshold value, determining that the optical navigation module is not tapped.

14. The tapping detection method according to claim 8, wherein after determining whether the tapping time is expired, further comprises:
when the tapping time is expired, determining that the optical navigation module is not tapped.

15. A computer readable recording medium which provides a program code executable by a processor of an optical navigation module, when the program code is executed by the processor, the method described in claim 1 is executed thereby.
